(19) United States
(12) Patent Application Publication
(10) Pub. No.: US 2005/0147762 A1
(43) Pub. Date: Jul. 7, 2005

(54) Method to fabricate amorphous electroless metal layers

(76) Inventors: Valery M. Dubin, Portland, OR (US); Chin-Chang Cheng, Portland, OR (US); Chih-I Wu, Taipei (TW)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,776

(22) Filed: Dec. 30, 2003

(51) Int. Cl. B32B 3/00; B05D 1/18; H05H 1/24; C23C 18/32; C23C 18/34

(52) U.S. Cl. 427/437; 427/443.1; 427/569; 106/1.21; 106/1.22; 106/1.24; 106/1.27; 106/1.28

(57) ABSTRACT

A metal alloy capping layer containing a group VIII metal and silicon, carbon, or nitrogen may be used to protect copper interconnects of integrated circuits from oxidation and to prevent the electromigration of copper interconnects while at the same time not effecting the performance of integrated circuit. Methods of incorporating the silicon, carbon, or nitrogen into the group VIII metal to form the metal alloy capping layer are also presented along with methods of electrolessly forming the cap on a metal interconnect line.

### BACKGROUND OF THE INVENTION

1. Field of the Invention

The present invention relates to the field of electroless plating, and more particularly to the application of electroless plating to the fabrication of interconnect structures in semiconductor devices.

2. Discussion of Related Art

Interconnect lines are often made of highly conductive metals or alloys. Copper has become a widely used material due in part to its low electrical resistance compared to other metals. However, one of the disadvantages of copper is that it readily oxidizes. Accordingly, if a copper surface is left exposed for prolonged periods of time, or subjected to a variety of etching or plasma cleaning operations, the surface may become oxidized. Unlike with other materials, such as aluminum, copper oxidation does not lead to a thin protective coating that blocks further oxidation, and significant portions of the copper may become oxidized. This is generally undesirable, because it may cause significant changes to the electrical and mechanical properties of the interconnect structure. Another disadvantage of copper is that it is easily etched with many of the commonly used dielectric etching chemistries. Accordingly, if the copper surface is left exposed, and unprotected, it can become oxidized or partly removed during subsequent processing operations.

In order to reduce oxidation and copper etching, protective dielectric etch stop or hard mask layers are often formed on copper interconnect lines. Materials that are commonly used for this purpose include silicon nitride (SiN), silicon carbide (SiC). Although these protective dielectric layers may be effective at protecting the copper from reaction, they often contribute to mechanical separations that lead to integrated circuit failure and they may increase the effective dielectric constant of the interconnect structure and lead to reduced performance. Additionally, the protective dielectric layers provide an additional material interface or junction where mechanical separation from the protective layers in the form of pilling, cracking, or blistering often occurs. These types of mechanical failures may reduce production yields and may decrease the effective lifetime of manufactured integrated circuits. The mechanical failures may be compounded when low dielectric constant materials (low-k), that have a dielectric constant less than silicon dioxide, are used as the interlayer dielectric of the interconnect structure. These low-k interlayer dielectrics are often chemically different from the protective dielectric layer materials and may also increase the effective dielectric constant of the interconnect structure. Such an increase in the dielectric constant may effectively decrease the speed of the integrated circuit and in turn lead to the reduced performance of the integrated circuit.

Another drawback to using copper is its diffusion or electromigration into dielectric materials that can result in the deterioration of devices. The diffusion of copper often requires the use of a diffusion barrier encapsulating or capping the copper interconnects. A variety of materials are known for forming diffusion barriers on copper. Such materials include the CoBP or CoWP alloys. These materials may be deposited electrolessly over the copper to form a metal cap. However, the cobalt containing materials may be oxidized, removed, or corroded during the etching or cleaning of vias or trenches. Also, copper may migrate through the cobalt containing materials into the surrounding dielectrics causing shorts, or oxygen may migrate into the copper through the cobalt based material causing oxidation of the copper interconnects. Yet another problem is that cobalt alloys such as CoBP and CoWP demonstrate thermal instability, meaning that they will not maintain an amorphous constituency upon heating at elevated temperatures in excess of 400° C. and will go through recrystallization.

### BRIEF DESCRIPTION OF THE DRAWINGS

FIG. 1 is an illustration of a cross-sectional view of an interconnect lines within an integrated circuit that have been capped with a metal capping layer.

FIGS. 2a-2g are illustrations of a method of fabricating a metal capping layer over metal interconnect lines.

### DETAILED DESCRIPTION OF THE PRESENT INVENTION

Described herein are methods and compositions for the electroless deposition of metal capping layers containing silicon, carbon, or nitrogen. In the following description numerous specific details are set forth. One of ordinary skill in the art, however, will appreciate that these specific details are not necessary to practice embodiments of the invention. While certain exemplary embodiments of the invention are described and shown in the accompanying drawings, it is to be understood that such embodiments are merely illustrative and not restrictive of the current invention, and that this invention is not restricted to the specific constructions and arrangements shown and described because modifications may occur to those ordinarily skilled in the art. In other instances, well known semiconductor fabrication processes, techniques, materials, equipment, etc., have not been set forth in particular detail in order to not unnecessarily obscure embodiments of the present invention.

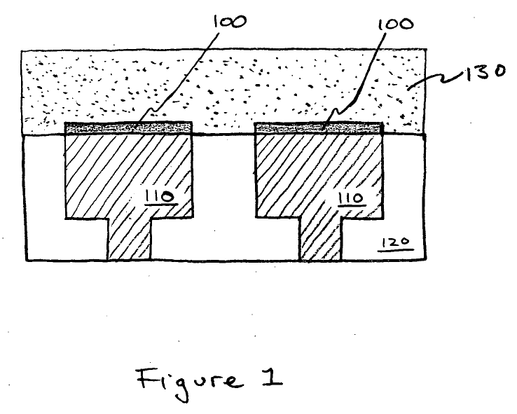

As illustrated in FIG. 1, a metal capping layer 100 containing a group VIII metal and silicon, carbon, or nitrogen may be used to protect metal interconnects 110 within dielectric 120 from oxidation by oxygen diffusion from the interlayer dielectric 130 and to prevent the electromigration of metal interconnects into an interlayer dielectric 130 while at the same time not effecting the performance of the integrated circuit. The interconnects 110 may be copper. Methods of incorporating the silicon, carbon, or nitrogen into the group VIII metal by electroless deposition and alternatively by post-treatments after an initial electroless deposition of the metal capping layer are also presented.

The metal capping layer 100 may be a composition of a group VIII metal and silicon, carbon, or nitrogen. The group VIII metals include: iron, cobalt, nickel, ruthenium, rhodium, osmium, and iridium. In an embodiment, the metal capping layer 100 may be an alloy of two or more group VIII metals, such as cobalt and nickel. The group VIII metal content present in the composition may be in the approximate range of 60 atomic percent and 95 atomic percent and more particularly in the approximate range of between 70 atomic percent and 90 atomic percent. The atomic percent of the group VIII metal in the composition may be reduced depending on whether other metals are alloyed with the group VIII metal. For example, the number of different metals in the alloy may be between 2 and 5. The group VIII metals have high melting points and may therefore increase the melting temperature of the metal capping layer. For example, ruthenium (Ru) has a melting point of approximately 2334° C. The increase in the melting temperature of the composition may depend on the amount of the group VIII metal included in the composition. Therefore, the group VIII metal may be present in the capping layer in an amount sufficient to increase the melting temperature of the metal capping layer. By including a large amount of ruthenium, for example between approximately 70 atomic percent and approximately 90 atomic percent, the melting temperature of the capping layer may be significantly increased. By increasing the melting temperature of the metal capping layer 100 the likelihood of recrystallization of the metal capping layer is reduced and the metal capping layer may maintain its amorphous character that is valuable in preventing corrosion and in preventing the diffusion of metal atoms out of the metal capping layer. Group VIII metals may also improve the selectivity of the deposition of the metal capping layer 100 to the dielectric layer 120 typically surrounding the interconnect lines 110 to be capped, meaning that the metal capping layer 100 electrolessly deposits on the interconnect lines 110 to be capped and not the dielectric layers 120 surrounding the interconnect lines 110.

The metal capping layer 100 also includes silicon, nitrogen, or carbon. These elements may be present in the capping layer either individually or in combination. As described later, these elements may be incorporated into the metal capping layer either by electroless deposition from an electroless plating bath or by implanting the elements in a post-plating process. Silicon, nitrogen, or carbon may be present in the metal capping layer 100 in the approximate range of 1 atomic percent and 10 atomic percent, and more particularly in the approximate range of 2 atomic percent and 5 atomic percent, either individually or in combination. The amount of these elements in the metal capping layer 100 is sufficient to increase the recrystallization temperature of the metal capping layer 100 formed of a group VIII metal or metal alloy by making the composition more amorphous. An increase in the recrystallization temperature may improve the corrosion resistance of the metal capping layer 100. Another advantage of incorporating Si, N, or C into the metal capping layer 100 is that these elements prevent the diffusion of elements throught he metal capping layer 100.

In an alternate embodiment, the composition of the metal capping layer 100 may, in addition to the group VIII metal and silicon, nitrogen, or carbon, also includes a group VIIB refractory metal or a group VIB refractory metal and combinations thereof. The group VIIB refractory metals include: manganese, technetium, and rhenium. The group VIB refractory metals include: chromium, molybdenum, and tungsten. The group VIIB or group VIB refractory metals may be present in the composition in the approximate range of between zero atomic percent and twenty atomic percent. The amount of the refractory metal included varies depending on the number of metals in the metal alloy. The group VIIB or group VIB refractory metals may further increase the melting temperature of the metal capping layer 100 by at least 600° C.

In yet another alternate embodiment, the composition of the metal capping layer 100 may also include either boron, phosphorous, or a combination of boron and phosphorous. The amount of boron in the composition may be in the approximate range of between zero atomic percent and 10 atomic percent, and more particularly in the approximate range of between 2 atomic percent and 8 atomic percent. The amount of phosphorous in the composition may be in the approximate range of between zero atomic percent and 20 atomic percent, and more particularly in the approximate range of between 5 atomic percent and 15 atomic percent. Boron and phosphorous may be present in the metal capping layer 100 in an amount sufficient to make the metal alloy capping layer 100 more amorphous, reduce the diffusion of metal atoms from the metal being capped into the ILD 130, reduce the diffusion of impurities into the metal being capped from the ILD 130, prevent oxidation of the metal interconnects 110 by promoting the formation of a passivation layer on the copper, and improve the deposition of the metal capping layer onto the metal interconnect lines to be capped.

In a particular embodiment, the composition of the metal capping layer 100 may include cobalt (a group VIII metal), silicon, boron or phosphorous, and one of the group VIIB refractory metals tungsten or rhenium. These compositions include, for example, CoPSi, CoBSi, CoBPSi, CoPC, CoBC, CoBPC, CoPN, CoBN, CoBPN, CoPSiW, CoBSiW, CoBPSiRe, CoPSiRe, CoBSiRe, CoBPSiRe, CoPSiMo, CoBSiMo, CoBPSiMo. It may be valuable to use cobalt or nickel as the group VIII metal because they are easy to incorporate into the composition using known electroless deposition techniques. Similarly, silicon may be added to the composition by a simple post-treatment of treating the capping layer with a plasma treatment using silane containing gases. Silicon may also be valuable because it has a high melting point and thus may increase the recrystallization temperature of the entire composition. Tungsten and Rhenium may also be valuable refractory metal alloys in this embodiment because they have high melting points and large atomic radii, properties that may lead to increasing the recrystallization temperature of the composition.

The metal capping layer may be formed by the electroless deposition of some or all of the elements of the composition of the metal capping layer. Electroless plating is a process for depositing a layer of material onto a surface by the chemical reduction of an electrolytic solution in the absence of an external electric current. The electroless deposition of the metal capping layer may result from the electrochemical reaction between the metal ions of the electrolytic solution and reducing agents on a catalytic surface. Complexing agents and pH adjusters may also effect the deposition of the layer of material onto a surface. Ions of the other components such as nitrogen, carbon, boron, and phosphorous may also be deposited by a similar electroless reaction.

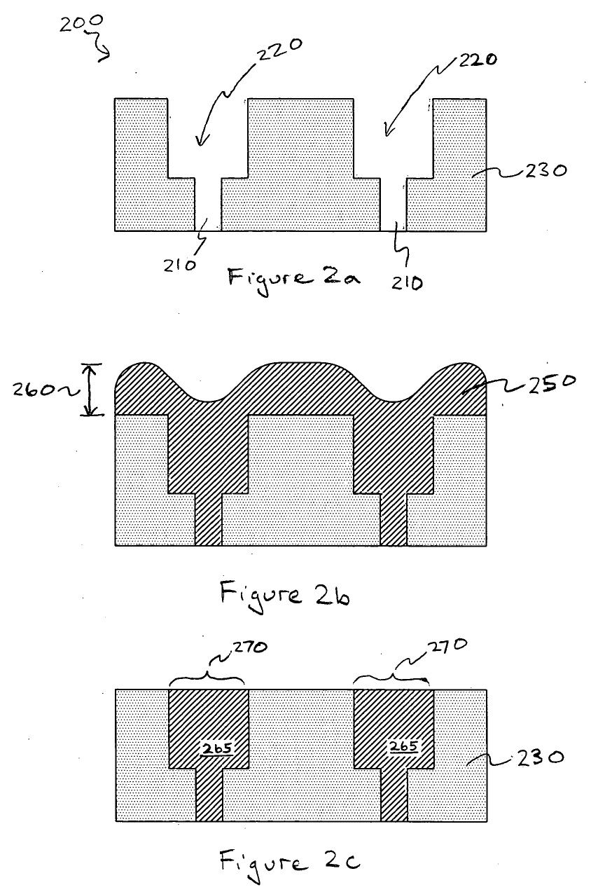

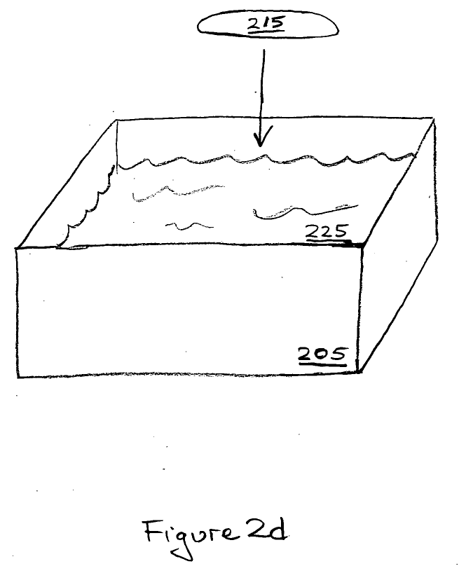

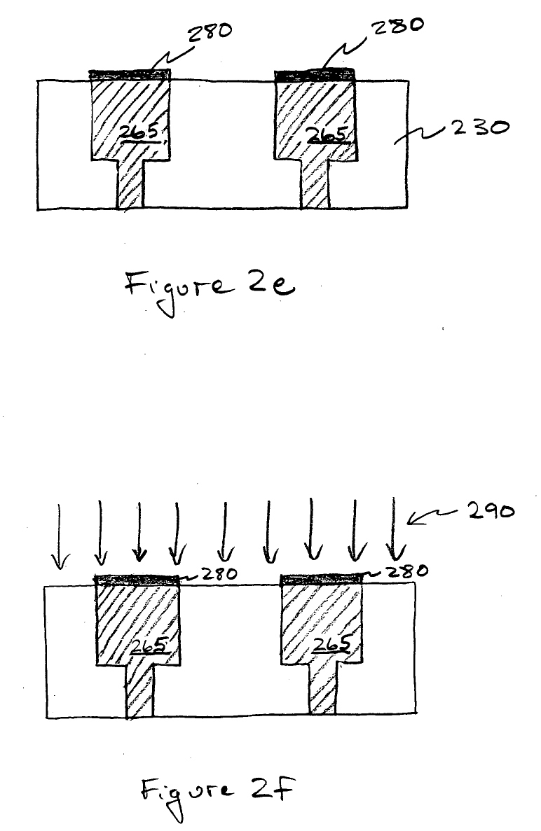

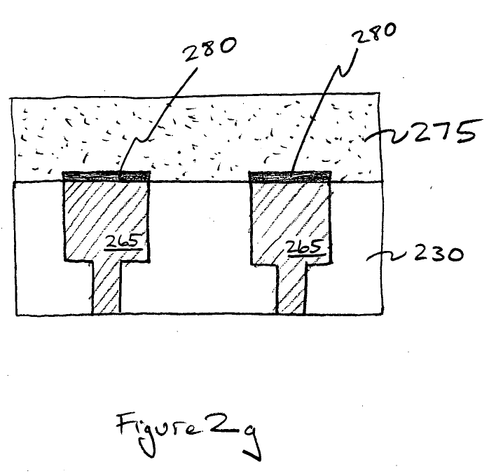

In one embodiment, the electroless plating solution may be applied to the surface of metal interconnect lines that are part of an integrated circuit. The metal interconnect lines may be copper. Copper interconnect lines may be formed by way of a damascene, or inlaid, metal process. A single damascene or a dual damascene process may be used. A dual damascene process, for example, may be used to form both vias and trenches in a single layer. FIG. 2a illustrates a dual damascene structure 200 after vias 210 and trenches 220 have already been etched into dielectric layer 230. In an embodiment, the barrier layer (not shown) lining the vias 210 and the trenches 220 may be formed of the composition described above to prevent the electromigration and oxidation of copper, that composition having the basic components of a group VIII metal combined with carbon, silicon, or nitrogen. FIG. 2b illustrates the dual damascene structure after the vias 210 and trenches 220 have been filled with copper 250. The excess copper layer 260 is then polished using chemical mechanical polishing (CMP), resulting in the planarized dual damascene structure illustrated in FIG. 2c. After CMP, copper interfaces 270 and the dielectric layer 230 are exposed at the top of the copper interconnect lines 265. The electroless plating solution may then be applied to this surface to the Cu interfaces and dielectric layer 130 to form a metal capping layer on the copper interconnect lines 265.

The electroless plating solution may be applied to the substrate in a full immersion bath, a spray bath, or a combination of the two. As illustrated in FIG. 2d a full immersion bath 205 completely immerses a substrate 215, such as a semiconductor wafer, in an electroless plating solution 225. The spray bath may use some type of dispersing apparatus, such as a spray bar, to disperse the electroless plating solution over the substrate. A combination bath may use a dispersing apparatus to disperse the processing fluid onto the substrate while filling the bath until the substrate is fully immersed by the fluid. The electroless plating bath may be applied to the substrate for a time sufficient to plate a metal alloy capping layer 280, as illustrated in FIG. 2e having a thickness in the approximate range of 50 angstroms and 200 angstroms.

The electroless plating solution 225 contains at least one group VIII refractory metal. In one embodiment the group VIII refractory metal is cobalt (Co.) The electroless plating solution 225 may also contain one or more group VIIB refractory metals, and alternatively or in addition to the group VIIB refractory metal, may also contain a group VIB refractory metal. Refractory metal ions from the groups VIII, VIIB, and VIB may be added to the electroless plating solution 225 by a compound containing ammonia (NH4) and the refractory metal, such as tungstate (NH4WO4) and NH4MoO4, or by a salt of the refractory metal, such as CoCl2.

In an embodiment, the substrate surface to which the electroless plating solution is to be applied may be activated. The copper interfaces 270 may be activated by applying a noble metal such as platinum or palladium to the portions of the copper interfaces 270 where the metal capping layer 280 is to be deposited. The copper interfaces 270 of a substrate may be activated and the dielectric material 230 surrounding the metal interconnect lines may not be activated. The copper interfaces 270 may not need to be activated if the electroless plating solution 225 includes a reducing agent such as dimethylamino borane (DMAB) or borohydrate because copper is a catalyst for the oxidation of DMAB or borohydrate.

The electroless plating solution 225 may also silicon, nitrogen, or carbon to incorporate those elements into the metal capping layer 280. These elements may be included in the electroless plating solution 225 if silicon, carbon, or nitrogen are not to be added to the capping layer 280 by a post-treatment, or if the elements are to be added to the capping layer 280 both from the electroless plating solution 225 and from the post-treatment. Nitrogen may be included in the bath as any low molecular weight (less than approximately 300 grams/mole) molecule containing nitrogen, such as hydrazine hydrate. Hydrazine hydrate and similar low molecular weight nitrogen containing compounds may be present in the electroless plating solution 225 in an amount between 5 g/l and 20 g/l. Carbon may be included in the electroless plating solution 225 as any low molecular weight molecule (less than approximately 300 grams/mole) containing carbon, such as glycine. Glycine and similar carbon containing compounds may be present in the electroless plating solution 225 in an amount between 10 g/l and 100 g/l. Silicon may be included in the electroless plating solution 225 as any low molecular weight molecule (less than approximately 300 grams/mole) containing silicon such as a silane. These compounds may be used individually or in combination.

Boron, phosphorous, or the combination of the two elements, may be incorporated into the metal capping layer 280 by adding compounds containing boron or phosphorous into the electroless plating solution 225. These compounds may be ones that also serve other purposes in the electroless plating solution 225, such as amino boranes which include dimethylaminoborane (DMAB), ammonium hypophosphite, and sodium hypophosphite that may also serve as reducing agents.

The electroless plating solution 225 may also include a reducing agent to assist in assuring metal deposition on the substrate as the substrate changes from the original copper interfaces 270 to the metal capping layer 280. Although the initial deposition of the metal capping layer 280 onto the copper interfaces 270 may be autocatalytic, the changing chemical environment of the substrate surface may interrupt the autocatalytic environment. Therefore, a reducing agent may be provided to assure continued metal capping layer 280 deposition despite the changing substrate surface. Examples of the reducing agent include dimethylaminoborane (DMAB), hypophosphites, and borohydrides. The amount of reducing agent added to the electroless plating solution 225 may be between 1 g/l and 100 g/l, and more particularly between 5 g/l and 30 g/l. These reducing agents containing boron or phosphorous may also deposit the elements boron or phosphorous into the metal capping layer 280.

The electroless plating solution 225 may also contain a complexing agent. The complexing agent may serve to complex to the refractory metals in the electroless plating solution 225 to prevent the precipitation of the refractory metals out of the electroless plating solution 225. The complexing agent may be a carboxylic acid, or a derivative of carboxylic acid such as citric acid, malonic acid, and lactic acid, or an amine such as ethylenediamine (EDA). The amount of complexing agent included in the electroless plating solution 225 may be a molar ratio of approximately 1:8 complexing agent in proportion to the metal to be complexed.

A pH adjuster may also be included in the electroless plating solution 225. The pH adjustor may be added to maintain the pH in the approximate range of 7 and 13, and more particularly in the range of 8 and 10. The pH may be determined by many factors, including the complexing agent, the reducing agent, the substrate, and the activating agent, and may therefore be difficult to predict. Examples of pH adjustors that may be used include tetramethyl ammonium hydroxide (TMAH) and potassium hydroxide (KOH). The amount of pH adjustor added to the electroless plating solution 225 may depend on the amount of acidic complexing agent added to the solution and on the target pH.

The various elements of the electroless plating solution 225 may be combined in a solvent or in a combination of solvents. Solvents that may be used include water and ethylene glycol. The amount of solvent used is based on how much solvent is needed to solvate the components of the electroless plating solution 225 and how large of a volume of the electroless plating solution 225 is required. In a typical example, the amount of solvent used is 1 liter and the chemical concentrations are normalized to 1 liter of solvent (chemicals volume+solvent=1 liter.) It is to be understood that the compounds within the electroless plating solution 225 may dissociate and recombine within the solvent to form different compounds.

After the electroless deposition, further elements 290 may be added to the metal capping layer 280 by a chemical vapor deposition post-treatment of the metal capping layer 280. Silicon, nitrogen, or carbon may be added to the metal capping layer 280 by a post-treatment instead of or in addition to incorporating these elements by electroless deposition. In one particular embodiment silicon may be added to the metal capping layer by the plasma enhanced chemical vapor deposition (PECVD) of a silane. Silane compounds that may be used as the reactant gases include SiH4. Alternatively, nitrogen may be incorporated into the metal capping layer 280 by a PECVD post-treatment with gases such as NH3. Also, carbon may be incorporated into the metal capping layer 280 by the PECVD of carbon containing gases such as carbon dioxide (CO2), methane (CH4), and ethane (CH3CH3). The reactant gases used to implant silicon, nitrogen, or carbon may be present in the chamber in an amount sufficient to incorporate up to approximately 10 atomic percent of silicon, nitrogen, carbon or a combination of these elements into the metal capping layer 280. In each of these embodiments, carrier gases such as N2, argon, and helium may be used in the deposition chamber, and the temperature of the chamber may be in the approximate range of 200° C. and 400° C. The silicon, nitrogen, or carbon may become incorporated into the metal capping layer 280 by diffusion. The deposition chamber may be the same chamber that is used to deposit the interlayer dielectric 275.

As illustrated in FIG. 2g, once the metal capping layer 280 has been formed, and has the desired composition of elements, an interlayer dielectric 275 may be formed above the metal capping layer 280 and the dielectric 230. The metal capping layer 280 may help to prevent the diffusion of the copper from the copper interconnect lines 265 into the interlayer dielectric 275. Also, the metal capping layer 280 may help to prevent the diffusion of oxygen from the interlayer dielectric 275 into the copper interconnect lines 265 and cause the oxidation of the copper interconnect lines 265.

Several embodiments of the invention have thus been described. However, those of ordinary skill in the art will recognize that the invention is not limited to the embodiments described, but can be practiced with modification and alteration within the scope and spirit of the appended claims that follow.

1. A method, comprising:
providing a substrate having a metal portion; and
forming a metal capping layer on the metal portion, the metal capping layer comprising a group VIII metal and an element comprising at least Si, N, or C.

2. The method of claim 1, wherein the group VIII metal is cobalt.

3. The method of claim 1, wherein the metal capping layer further comprises a refractory metal.

4. The method of claim 1, further comprising forming the metal capping layer on the metal portion by applying an electroless plating solution to the metal portion of the substrate.

5. The method of claim 4, wherein the electroless plating solution is applied to the metal portion for a time sufficient to form a metal capping layer having a thickness in the approximate range of 50 angstroms and 200 angstroms.

6. The method of claim 1, wherein forming a metal capping layer on a metal portion comprises forming a metal capping layer on a copper interconnect line.

7. A method comprising:
providing a substrate having a metal portion; and
forming a metal capping layer on the metal portion, the metal capping layer comprising a group VIII metal; and
incorporating an element comprising at least Si, N, or C by a plasma enhanced chemical vapor deposition treatment of the metal capping layer after forming the metal capping layer on the metal portion.

8. The method of claim 7, wherein Si is incorporated into the metal capping layer by the plasma enhanced chemical vapor deposition of a silane.

9. The method of claim 7, wherein the metal portion is copper.

10. A composition, comprising:
a group VIII metal; and
an element comprising at least Si, N, or C.

11. The composition of claim 10, wherein the group VIII metal is cobalt.

12. The composition of claim 10, wherein the group VIII metal is present in the composition in the approximate range of 60 atomic percent and 95 atomic percent.

13. The composition of claim 10, wherein the group VIII metal is alloyed with at least a second metal.

14. The composition of claim 13, wherein the second metal is a group VIIB refractory metal that is present in the composition in the approximate range of zero atomic percent and 20 atomic percent.

15. The composition of claim 1, wherein the element comprising at least Si, N, or C is present in the composition in the approximate range of 1 atomic percent and 10 atomic percent.

16. The composition of claim 14, wherein the second metal is a group VIB refractory metal that is present in the composition in the approximate range of zero atomic percent and 20 atomic percent.

17. The composition of claim 1, further comprising boron that is present in the composition in the approximate range of zero atomic percent and 10 atomic percent.

18. The composition of claim 1, further comprising phosphorous that is present in the composition in the approximate range of zero atomic percent and 20 atomic percent.

19. An electroless plating solution, comprising:
a group VIII refractory metal containing compound;
a low molecular weight compound containing an element comprising at least Si, N, or C;
a complexing agent;
a buffer agent;
a pH adjuster.

20. The solution of claim 19, wherein the group VIII refractory metal containing compound also contains ammonia.

21. The solution of claim 19, wherein the group VIII refractory metal containing compound is a salt of the group VIII refractory metal.

22. The solution of claim 19, wherein the low molecular weight molecule containing nitrogen is hydrazine hydrite.

23. The solution of claim 19, wherein the low molecular weight carbon containing compound is glycine.

24. The method of claim 19, further comprising a reducing agent.

25. A method comprising:
increasing a recrystallization temperature of a composition containing a group VIII metal by adding an element comprising at least Si, N, or C to the composition.

26. The method of claim 25, wherein increasing the recrystallization temperature further comprises adding a refractory metal to the composition.

27. The method of claim 25, wherein increasing the recrystallization temperature further comprises adding an element selected from the group consisting of boron and phosphorous to the composition.

28. An apparatus, comprising:
a metal interconnect line within a dielectric layer; and
a metal capping layer formed above the metal interconnect line, the metal capping layer comprising a group VIII refractory metal and an element comprising at least Si, C, or N.

29. The apparatus of claim 28, wherein the metal interconnect line is copper.

30. The apparatus of claim 28, wherein the metal capping layer has a thickness in the approximate range of 50 angstroms and 200 angstroms.
